(19) United States
(12) Patent Application Publication
(10) Pub. No.: US 2024/0086654 A1
(43) Pub. Date: Mar. 14, 2024

(54) METHOD AND SYSTEM FOR WIRELESS TAG USER CONFIGURATION FOR COLLABORATIVE CONTENT GENERATION MANAGEMENT AND ANALYTICS

(71) Applicants: Nittn WARSHNE, Ghaziabad (IN); Bhwna WARSHNE, Ghaziabad (IN)

(72) Inventors: Nittn WARSHNE, Ghaziabad (IN); Bhwna WARSHNE, Ghaziabad (IN)

(21) Appl. No.: 18/263,648

(22) PCT Filed: Feb. 4, 2022
(86) PCT No.: PCT/IB2022/050998

§ 371 Date: Jul. 31, 2023

(30) Foreign Application Priority Data
Feb. 5, 2021 (IN) 202111005106

(51) Int. Cl. G06K 7/10

(52) U.S. Cl. CPC G06K 7/10227

(57) ABSTRACT

Various embodiments of the invention provide a system and a method for user interaction, configuration and content management using wireless tags data linking physical objects. The method includes attaching wireless tags to static objects and configuring the wireless tags to provide information on one or more of: managing inventories, user digital content generation, and publishing to online collaborative album and public publish, online social media. The method also enables the user to generate content and may provide incentives to user for the generated content and method of acquiring copyright consent for commercial use. The method also provided access control to the collaborative album for high quality sharing of photos and for easy addition and deletion of users. The method also performs analytics and provides rewards and offers for different target uses of content thereby increasing public visibility of an organizer.

### TECHNOLOGICAL FIELD

Example embodiments of the present disclosure generally relate to a user management system for wireless tag configuration Including Geo fencing to detect user wirelessly at a location and for content management system of collaborative user content generation using wireless tag attached with objects, with wireless tags having info of object, event, location, user task, publish and user rewards, and more particularly relate to a system of publishing a content of user generated content on user detection and engagement with an event organizer or user configured wireless tags or triggers used with objects of visual enhancement of a location for promotion of products, services or event for user rewards, content management and analysis.

### BACKGROUND

User (for example people, invitees, guests customers etc.) engagement refers to an interaction between an organizer or organization and its users through various online and offline channels. Online user engagement is different from offline engagement as the nature of the users' interactions with a brand, company, event and other users differ on the internet. Online Discussion forums, online media, online social media networks, blogs, for example, are spaces where people can communicate, socialize and review about various topics online and offline. The user engagement happens on both online and offline. The offline user engagement happens to be at a physical location. The user may be attracted by visual enhancements or decorations created with combination of objects at a location, shop window decoration, branding display, interior decoration along with visual attractions like info objects, banners, mascots, signage, discount offers and the like. It is important for the organizer or organization to know how many users were attracted and generated content using the visual enhancement and decorations, and how many users published the content. How the user generated content is published, accessed and tracked, how the content is used online or offline by organizer or organization, how to provide rewards to user, and the like. Currently there is no system or method for the organizer or organization to know exactly how many people were attracted by the visual enhancement decoration along with providing reward for user content generated and published.

Almost everybody has access to camera or camera enabled devices these days, resulting in more impromptu photo content generation. Most of the photos at an event may be taken by attendees like friends, family or 3^{rd} person, guests or customers' cameras. Once the event is over we need to physically track the photo owner to exchange the photos through some communication medium. This track and trace of photo content is time consuming and cumbersome. Most of the good photo content of an event is not shared, and even if they are shared the content quality is not good for enlargement or print purposes. Almost all the organizers of an event requires collection of photos taken by all the attendees by granting them automatic temporary access to submit photo content to organizer controlled event album for a temporary period or instances. This organizer controlled event album enables automatic collection of user photo content on interaction with wireless tag, without manually adding and then removing each and every attendee. This collection of user content may be used by organizer for private, social, public or commercial use. Currently there is no standalone system of event based user generated content collaborative album or, and using collaborative user content for publishing to online or offline media, with or without user rewards for commercial uses along with content management and analytics.

The retail store has inventories to be shown to the customer. The retail store also has to create data for ecommerce or inventory management. Further the retail store has to track the inventories so that no goods are lost or stolen. Conventionally, the retail stores utilize wireless tags such as QR image (Quick response image), Radio Frequency Identification (RFID), NFC tags, Bluetooth beacons and similar tags capable of interaction with device on detection, that are attached to each inventory. However, the conventional wireless tag cannot be used unless all the information is provided properly by concerned persons. Normally after the tag has been configured by an Admin, it is often required by other people to submit response regarding object used with the tag, responses such as object identity, color, size, delivery info, location update, campaign changes, internet keyword changes, social media hashtags, social media accounts, offer changes and the like. These changes may be required by authorized person on receiving the object. Changes of location, or campaign alteration is communicated to admin through some communication medium, which results in loss of time and additional processes and procedures which are unnecessary. It is also important for the retail store to get insights on their customer's buying pattern and recommend products based on insights. Currently, there is no standalone solution for a brand to constantly engage with customer, monitor the inventory using wireless tags and gather analytical insights from customers.

Therefore, there is a need to provide a solution to overcome the above-mentioned limitations. More specifically, there is a need of the solution that provides user interaction and engagement, content generation, collection, rewards and management using wireless tags to data link physical objects.

### SUMMARY

Various embodiments provide method and system of user interaction, configuration and engagement management using wireless tags to data link the physical objects. The wireless tags may be multi part configuration wireless tags or normal single configuration attached with real-world tangible objects for one or more of information for managing inventories, object information location, user tasks for digital content generation, publishing to online collaborative album, online publishing, offline publishing, social publishing etc. with user rewards, object or subject information, analytics, extended multiple user rewards for private and commercial publication to internet media, online or offline media with copyright and content management. Configuration of the wireless tags may be divided into various fragments such that each fragment can be assigned or left unassigned for a defined or undefined user for example Store admin, Store manager, Salesperson, accountant etc to alter or update wireless tag information required for final outcome or intended final use of the wireless tag. Configuration information may also include wireless digital information like object, subject, event, location, online keywords, rewards or offers information, Machine learning (ML) information, Augmented Reality (AR) information, digital data embedded objects or enabled devices for example, Like Store installed internet connected devices, computer, Ipad tablets enabling user engagement and interaction, which are capable of wireless detection and facilitate data transfer to devices. After all the configuration information is complete, the wireless tag can be used for final intended processes.

In some embodiments, the system may enable user to generate user content and providing to user generated content collaborative database content using wireless tag to data link objects. The system may also provide rewards to the user based on tasks, processes and analytics performed on data retrieved from the wireless tags. This system may also be used to judge the admiration or acceptance of the user to look at the shop window, and how many customers entered the shop or completed purchase after interaction with data linked objects. Also, the system may be configured to make an announcement by organizer for new object like artwork installation at a place to attract footfall of the user. The system also judges user acceptance of a visually enhancing object, directly from the user. The system also ensures generating original digital content using visual enhancement objects and provides the original user generated content to campaign owner or organizer for further use.

In an aspect of the invention a computer-network implemented system for managing content for publication is disclosed, comprises a data storage module configured to store one or more profiles of one or more host facilities. The system further comprises one or more wireless access modules encoded with information to provide an access for a web-based platform to a user. The the one or more wireless access modules are implemented on the one or more host facilities. The data storage module is to store unique identification code (UID) of each wireless detection module. The system further comprises a user equipment having one or more media recording units and configured to connect with the one or more wireless access modules to receive the encoded information for gaining access to the web-based platform. The web-based platform is configured to receive inputs by the user. The system further comprises a processor communicably coupled to the data storage module wherein the processor is configured to process the inputs received on the web-based platform, create one or user profiles based on the received inputs, store the one or user profiles on the data storage module corresponding to the one or more profiles of the one or more host facilities, generate a first electronic consent for the user to access and monitor the one or more media recording units, upon agreeing to the first electronic consent by the user, monitor electronic signals representing recording of media by the one or more media recording units, generate a second electronic consent for the user to receive the media recorded by the one or more media recording units, and upon agreeing to the second electronic consent by the user, store the recorded media on the data storage module.

In another aspect of the invention, a computer-network implemented method for managing content for publication is disclosed, comprising storing one or more profiles of one or more host facilities on a data storage module; providing an access for a web-based platform to a user via one or more wireless access modules encoded with access information. The one or more wireless access modules are implemented on the one or more host facilities. The data storage module is to store unique identification code (UID) of each wireless detection module. A user equipment is connected with the one or more wireless access modules to receive the encoded information for gaining access to the web-based platform. The web-based platform is configured to receive inputs by the user. The method, via a processor, comprises processing the inputs received on the web-based platform; creating one or user profiles based on the received inputs; storing the one or user profiles on the data storage module corresponding to the one or more profiles of the one or more host facilities; generating a first electronic consent for the user to access and monitor the one or more media recording units; upon agreeing to the first electronic consent by the user, monitoring electronic signals representing recording of media by the one or more media recording units; generating a second electronic consent for the user to receive the media recorded by the one or more media recording units; and upon agreeing to the second electronic consent by the user, storing the recorded media on the data storage module.

In another aspect of the invention, a non-transitory computer-readable storage medium having a program to perform a method for managing content is disclosed, wherein the method comprises storing one or more profiles of one or more host facilities on a data storage module; providing an access for a web-based platform to a user via one or more wireless access modules encoded with access information. The one or more wireless access modules are implemented on the one or more host facilities. The data storage module is to store unique identification code (UID) of each wireless detection module. A user equipment is connected with the one or more wireless access modules to receive the encoded information for gaining access to the web-based platform. The web-based platform is configured to receive inputs by the user. The method, via a processor, comprises processing the inputs received on the web-based platform; creating one or user profiles based on the received inputs; storing the one or user profiles on the data storage module corresponding to the one or more profiles of the one or more host facilities; generating a first electronic consent for the user to access and monitor the one or more media recording units; upon agreeing to the first electronic consent by the user, monitoring electronic signals representing recording of media by the one or more media recording units; generating a second electronic consent for the user to receive the media recorded by the one or more media recording units; and upon agreeing to the second electronic consent by the user, storing the recorded media on the data storage module.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an environment representation for a user interaction, configuration and content management system, in accordance with an example embodiment of the present disclosure;

FIG. 2 shows a block diagram of user interaction, configuration and content management system of FIG. 1, in accordance with an example embodiment of the present disclosure;

FIG. 3 shows a flowchart depicting a method flow for configuring wireless tags, in accordance with an example embodiment of the present disclosure;

FIG. 4 shows a flowchart depicting a method flow for user interaction, configuration and content management system, in accordance with an example embodiment of the present disclosure;

FIG. 5 shows a block diagram of a system for managing content for publication, in accordance with an example embodiment of the present disclosure; and

FIG. 6 shows a flowchart of a method for managing content for publication, in accordance with an example embodiment of the present disclosure.

### DETAILED DESCRIPTION

In the following description, for purposes of explanation, numerous specific details are set forth in order to provide a thorough understanding of the present disclosure. It will be apparent, however, to one skilled in the art that the present disclosure may be practiced without these specific details.

Throughout the following description, numerous references may be made regarding database, servers, services, or other systems formed from computing devices. It should be appreciated that the use of such terms is deemed to represent one or more computing devices having at least one processor configured to or programmed to execute software instructions stored on a computer readable tangible, non-transitory medium or also referred to as a processor readable medium. For example, a server can include one or more computers operating as a web server, data source server, or other type of computer server in a manner to fulfill described roles, responsibilities, or functions. Within the context of this document, the disclosed modules are also deemed to comprise computing devices having a processor and a non-transitory memory storing instructions executable by the processor that cause the device to control, manage, or otherwise manipulate the features of the devices, data or systems.

The embodiments are described herein for illustrative purposes and are subject to many variations. It is understood that various omissions and substitutions of equivalents are contemplated as circumstances may suggest or render expedient but are intended to cover the application or implementation without departing from the spirit or the scope of the present disclosure. Further, it is to be understood that the phraseology and terminology employed herein are for the purpose of the description and should not be regarded as limiting. Any heading utilized within this description is for convenience only and has no legal or limiting effect.

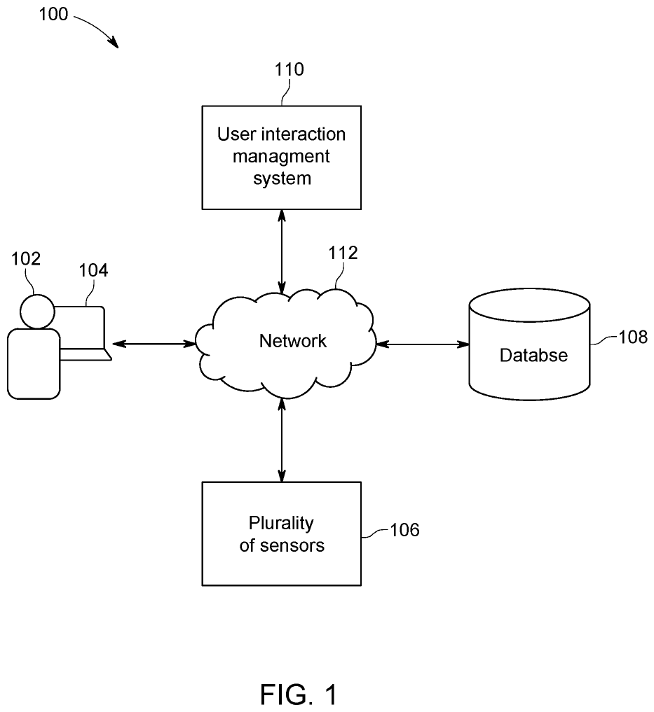

FIG. 1 illustrates an environment representation 100 of a user interaction, configuration and content management system 110 for interacting with a user 102, in accordance with an example embodiment of the present disclosure. The user 102 is associated with a readable device 104. The readable device 104 may include, but not limited to a desktop computer, a laptop, a smart mobile phone, a portable handheld device used for communication, scanning, reading or detecting. The user 102 may be a general people, end user, guests, invitee, attendants, consumer, an administrator or a business professional. The user 102 may set up an account via an application interface in the device 104. When the user 102 is a consumer, the user interaction, configuration and content management system 110 may provide targeted information so that the consumer is attracted to buying a product. The user interaction, configuration and content management system 110 may utilize plurality of sensors 106 to enable static objects to transmit data. The plurality of sensors comprises one or more of a wireless tag such as RFID, a beacon, Near Field Communication (NFC), Quick Response (QR), geofencing detection and the like. The static objects such as Mannequins, Blackboards, artworks, dresses, shoes and the like are converted into data linked objects by utilizing the plurality of sensors 106. The plurality of sensors 106 transmits data to the user interaction, configuration and content management system 110 via a network 112.

The network 112 may comprise suitable logic, circuitry, and interfaces that may be configured to provide a plurality of network ports and a plurality of communication channels for transmission and reception of data. Each network port may correspond to a virtual address (or a physical machine address) for transmission and reception of the communication data. For example, the virtual address may be an Internet Protocol Version 4 (IPv4) (or an IPv6 address) and the physical address may be a Media Access Control (MAC) address. The network 112 may be associated with an application layer for implementation of communication protocols based on one or more communication requests from at least one of the one or more communication devices. The communication data may be transmitted or received, via the communication protocols. Examples of such wired and wireless communication protocols may include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

Examples of the network 112 may include, but is not limited to a wireless channel, a wired channel, a combination of wireless and wired channel thereof. The wireless or wired channel may be associated with a network standard which may be defined by one of a Local Area Network (LAN), a Personal Area Network (PAN), a Wireless Local Area Network (WLAN), a Wireless Sensor Network (WSN), Wireless Area Network (WAN), Wireless Wide Area Network (WWAN), a Long Term Evolution (LTE) network, a plain old telephone service (POTS), and a Metropolitan Area Network (MAN). Additionally, the wired channel may be selected on the basis of bandwidth criteria. For example, an optical fiber channel may be used for a high bandwidth communication. Further, a coaxial cable-based or Ethernet-based communication channel may be used for moderate bandwidth communication.

The user interaction, configuration and content management system 110 stores and maintains data in a database 108. The database 108 comprises collaborative content data generated by the consumers/users and sensor data obtained from the wireless tags. In some embodiments, the database 108 may comprise access control information, configuration information, and marketing campaign related information. In one example embodiment, the database 108 may be embodied within the interaction, configuration and content management system 110. In another example embodiment, the database 108 may be remotely connected to the interaction and content management system 110 through the network 112. The user interaction, configuration and content management system 110 may enforce access control on the database 108 for different types of users 102 and for different actions to be performed by the user 102. The data in the database 108 is protected by encryption, password protection, access controls and the like.

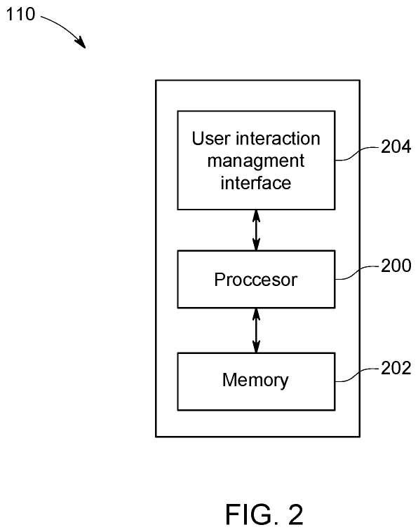

The user interaction, configuration and content management system 110 may be embodied as a cloud-based service or within a cloud-based platform. The detailed description of the interaction, configuration and content management system 110 is further described with reference to FIG. 2.

FIG. 2 illustrates a block diagram of the user interaction, configuration and content management system 110, in accordance with an example embodiment of the present disclosure. The user interaction, configuration and content management system 110 (also referred as “the system 110”) may comprise a processing means such as processor 200, storage means such as memory 202, and a communication means such as user interaction, configuration and content management interface 204. The processor 200 may retrieve computer program code instructions in the memory 202 for execution of the computer program code instructions.

The processor 200 may be embodied in a number of different ways. For example, the processor 200 may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, sensor reading capability or the like. As such, in some embodiments, the processor 200 may include one or more processing cores configured to perform independently. A multi-core processor may enable multiprocessing within a single physical package. Additionally or alternatively, the processor 200 may include one or more processors configured in tandem via the bus to enable independent execution of instructions, pipelining and/or multithreading. Additionally or alternatively, the processor 200 may include one or more processors capable of processing large volumes of workloads and operations to provide support for big data analysis. In an example embodiment, the processor 200 may be in communication with a memory 202 via a bus for passing information among components of the user interaction, configuration and content management system 110.

The memory 202 may be non-transitory and may include, for example, one or more volatile and/or non-volatile memories. In other words, for example, the memory 202 may be an electronic storage device (for example, a computer readable storage medium) comprising gates configured to store data (for example, bits) that may be retrievable by a machine (for example, a computing device like the processor 200). The memory 202 may be configured to store information, data, content, applications, instructions, or the like, for enabling the apparatus to carry out various functions in accordance with an example embodiment of the present invention. For example, the memory 202 could be configured to buffer input data for processing by the processor 200. As exemplarily illustrated in FIG. 2, the memory 202 may be configured to store instructions for execution by the processor 200. As such, whether configured by hardware or software methods, or by a combination thereof, the processor 200 may represent an entity (for example, physically embodied in circuitry) capable of performing operations according to an embodiment of the present invention while configured accordingly. Thus, for example, when the processor 200 is embodied as an ASIC, FPGA or the like, the processor 200 may be specifically configured hardware for conducting the operations described herein. Alternatively, as another example, when the processor 200 is embodied as an executor of software instructions, the instructions may specifically configure the processor 200 to perform the algorithms and/or operations described herein when the instructions are executed. However, in some cases, the processor 200 may be a processor specific device (for example, a mobile terminal or a fixed computing device) configured to employ an embodiment of the present invention by further configuration of the processor 200 by instructions for performing the algorithms and/or operations described herein. The processor 200 may include, among other things, a clock, an arithmetic logic unit (ALU) and logic gates configured to support operation of the processor 200.

The user interaction, configuration and content management interface 204 may comprise input interface and output interface for supporting communications to and from any component with which the user interaction, configuration and content management system 110 may communicate. The user interaction, configuration and content management interface 204 may be any means such as a device or circuitry embodied in either hardware or a combination of hardware and software that is configured to receive and/or transmit data to/from a communications device and sensors. In this regard, the user interaction, configuration and content management interface 204 may include, for example, an antenna (or multiple antennae) and supporting hardware and/or software for enabling communications with a wireless communication network and wireless tags and sensors. Additionally or alternatively, the user interaction, configuration and content management interface 204 may include the circuitry for interacting with the antenna(s) to cause transmission of signals via the antenna(s) or to handle receipt of signals received via the antenna(s). In some environments, the user interaction, configuration and content management interface 204 may alternatively or additionally support wired communication. As such, for example, the user interaction, configuration and content management interface 204 may include a communication modem and/or other hardware and/or software for supporting communication via cable, digital subscriber line (DSL), universal serial bus (USB) or other mechanisms. In some example embodiments, the user interaction, configuration and content management interface 204 may include an application interface that may be installed in user devices, such as the user device 104.

The processor 200 is configured to receive data from plurality of sensors 106 such as wireless tags that are attached to the static objects. The processor is configured to store the data received from the wireless tags in the database 108. The database 108 may be a collaborative database of multiple users that can be accessed by multiple users. Further, the processor 200 is configured to provide access control to the collaborative database so that privacy and security of data stored in the database 108 is maintained. The processor 200 is configured to receive information related to user generated content. The processor 200 may then generate a collaborative album based on the user generated content. The collaborative album enables users to share high quality content. The processor 200 is configured to use wireless tags to automatically fetch information database 108 on engagement with smart device by the user 102. The user interaction, configuration and content management system 110 provides automatic temporary access to object, subject, location, event, publish information specific collaborative album. Therefore, new users are able to enroll, access, and submit content within a very short duration of time. Further, the processor 200 is configured to enable the admin of the user interaction, configuration and content management system 110 to control quality, quantity and duration of content submission of the collaborative album.

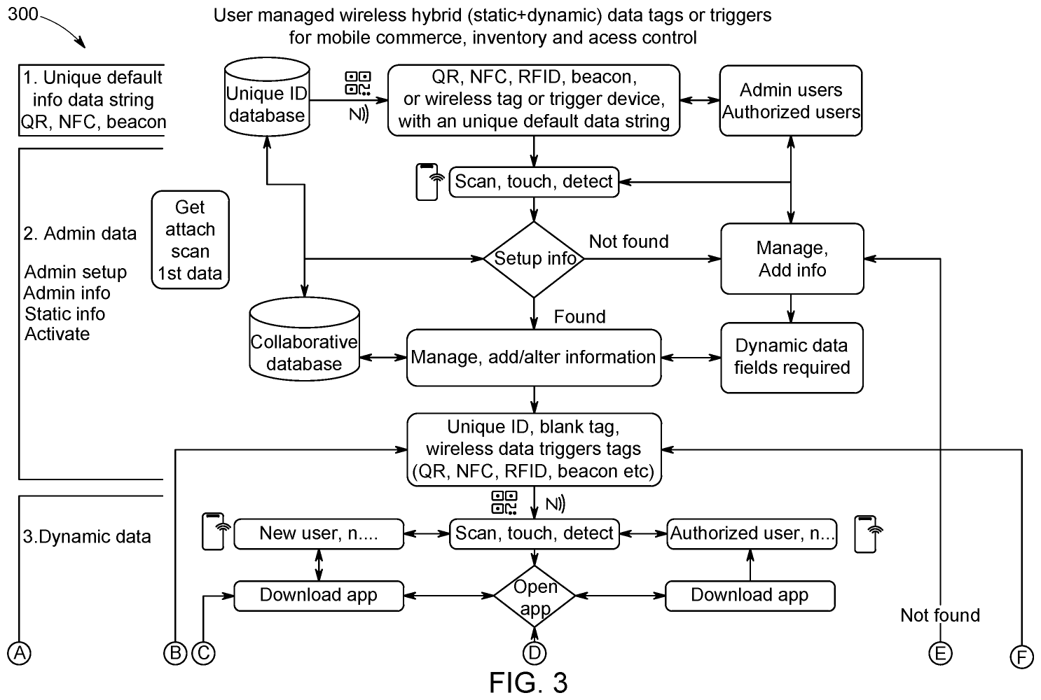

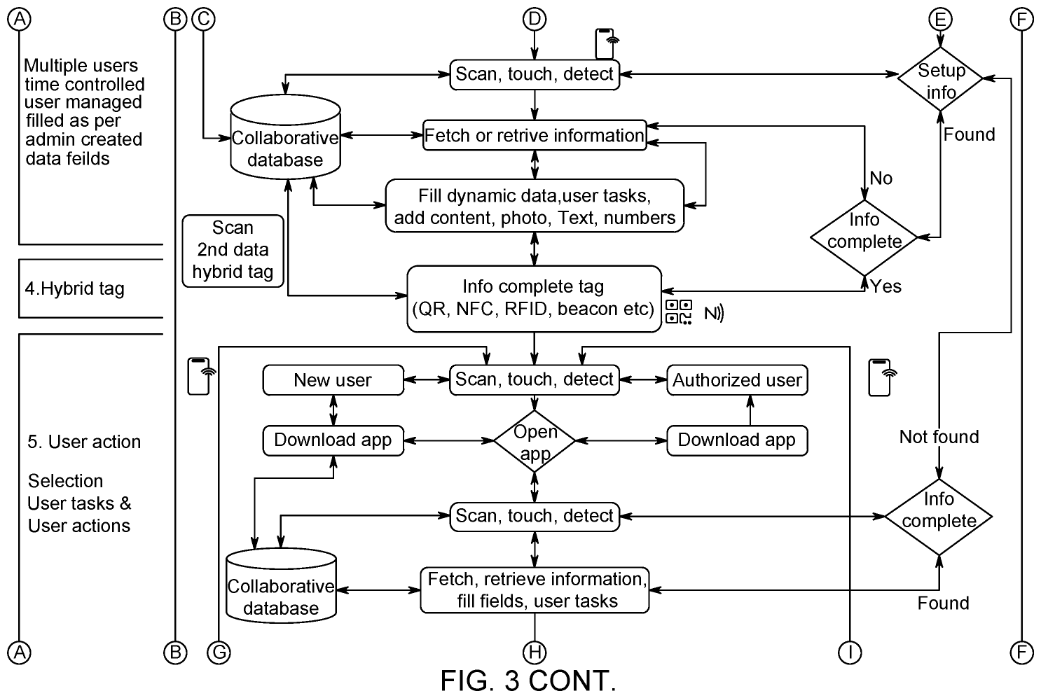

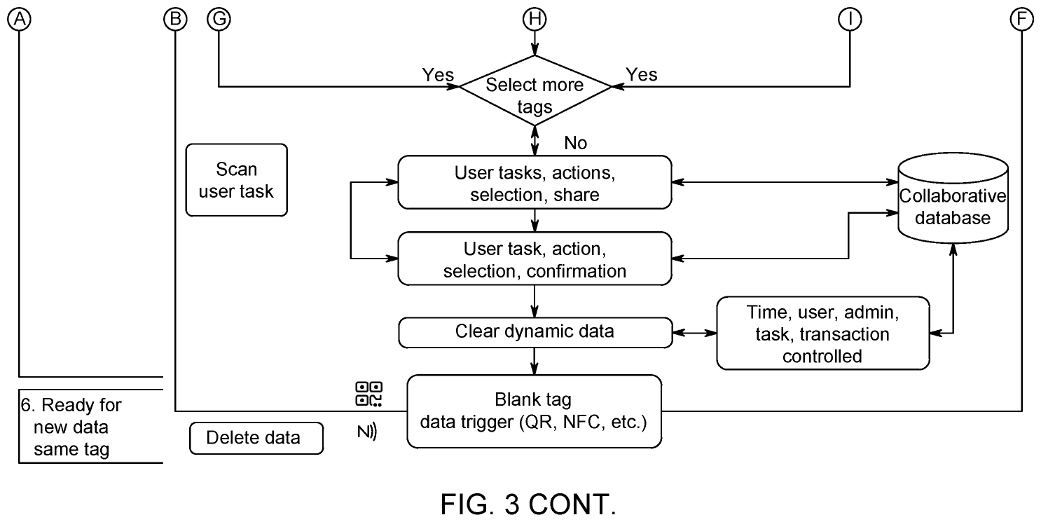

The configuration of the wireless tags by the user interaction, configuration and content management system 110 for mobile commerce, inventory and access control is described with reference to FIG. 3.

FIG. 3 shows a flowchart depicting method flow 300 for configuring wireless tags, in accordance with an example embodiment of the present disclosure. The method 300 is executed by the processor 200 of the user interaction, configuration and content management system 110 to upgrade static objects into data linked objects. The method starts at step 302 and ends at step 312.

At step 302, default data associated with the wireless tags are obtained. The default data of the wireless tags comprise a combination of integers, strings, alphanumeric codes and the like that forms a unique identifier or a setup information. The unique ID may be stored in the database 108 and can be accessed by the administrator or user of the system 110.

At step 304, the default data of the wireless tags are accessed by the administrator or user by at least one user by scanning, and touch or wireless detection. When the setup information of the wireless tags are not found, the method asks to add the setup information dynamically in real time. To add the setup information in real time, the system 110 adds dynamic data fields so that the administrator or user can add the setup information. The administrator user can add, delete, and modify the setup information. The setup information along with the unique ID is stored in a collaborative database. The collaborative database is part of the database 108.

At step 306, the user tasks and details are obtained for the user 102. The user may download the application and input the details via the user interaction, configuration and content management interface 204 of the system 110. Also, multiple users can access the application in real time and input user information simultaneously. The user information is entered according to data fields setup the administrator users. The user information entered at real time is also referred as dynamic data. The dynamic data is stored in the database 108.

At step 308, information from a hybrid wireless tag is obtained. The hybrid wireless tag may be one or more of a RFID, NFC, a beacon, OR and the like. The information present in the hybrid tags may also contain user information, information obtained from user's device and the like. The hybrid tags may store dynamic data such as timestamp of activity performed by user, number of transactions performed by user and the like.

At step 310, users 102 are provided tasks that can be performed by the user and tracked by the hybrid tags. The user 102 may open the user interaction, configuration and content management interface 204 and perform the activity. The activity is then stored in the collaborative database. The collaborative database is part of the database 108. The user interaction, configuration and content management system 110 may retrieve the information from the database 108 and determine whether more hybrid tags are needed. If it is determined that more hybrid tags are needed, the system 110 may begin scanning for more hybrid tags. Subsequently, the activities of the user 102 to be performed are selected. Further, the activities or tasks performed by the user are confirmed and stored in the collaborative database 108.

At step 312, the dynamic data stored in the hybrid tags may be deleted and reused with new user data after predetermined time duration, after completion of transaction, user details, type of task performed, or any other administrator user specification to reset the information associated with the tag in the collaborative database 108. The hybrid tags can be used for gathering new information since the dynamic data of the hybrid tags are erased. Therefore, the same tags can be used to collect new data in real time. The method may proceed to step 306 to collect fresh dynamic data from the user 102 and the cycle is repeated from method step 306 to method step 312. The data stored in the collaborative database 108 is utilized by the user interaction, configuration and content management system 110 for performing one or more of: analytics, access control, e-commerce, marketing campaigns, inventory control, advertisement, security of inventory and the like.

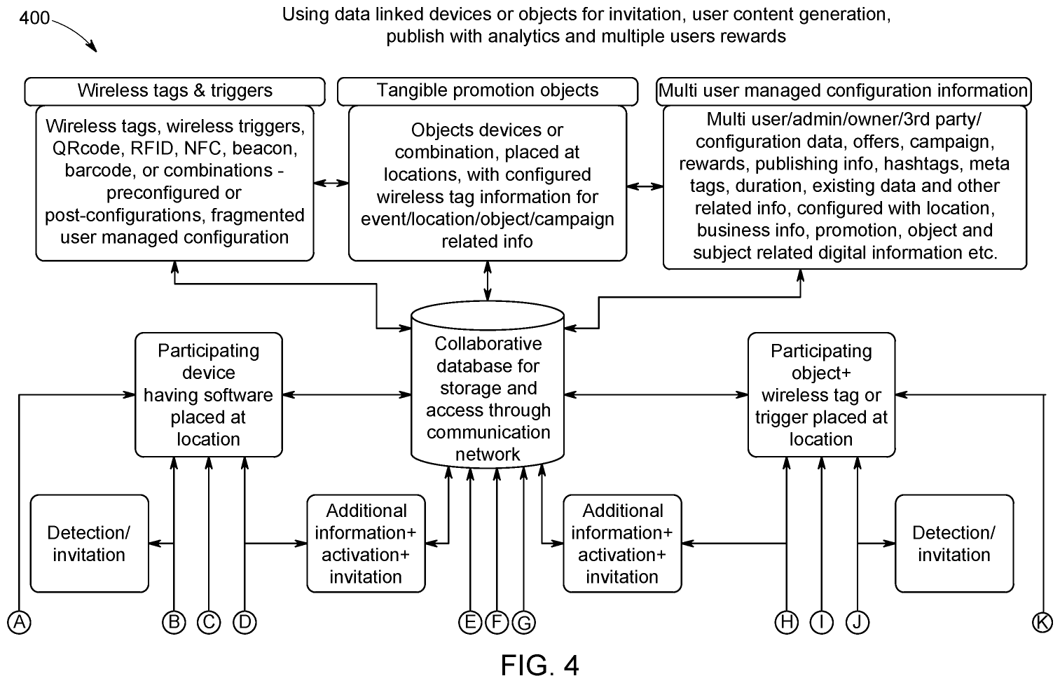

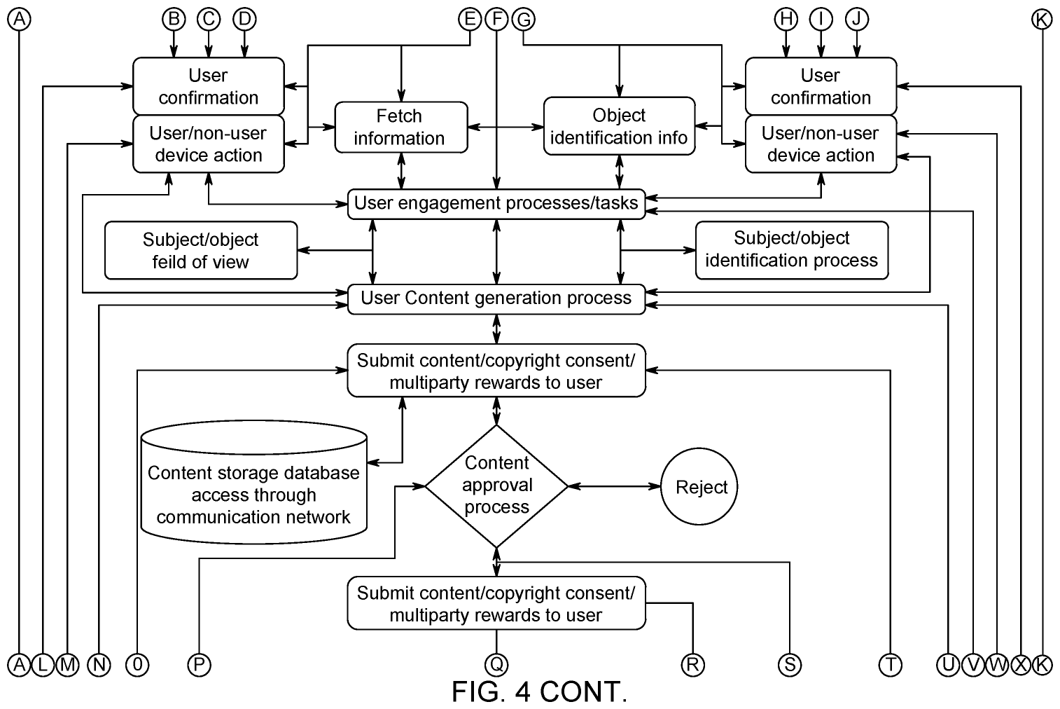

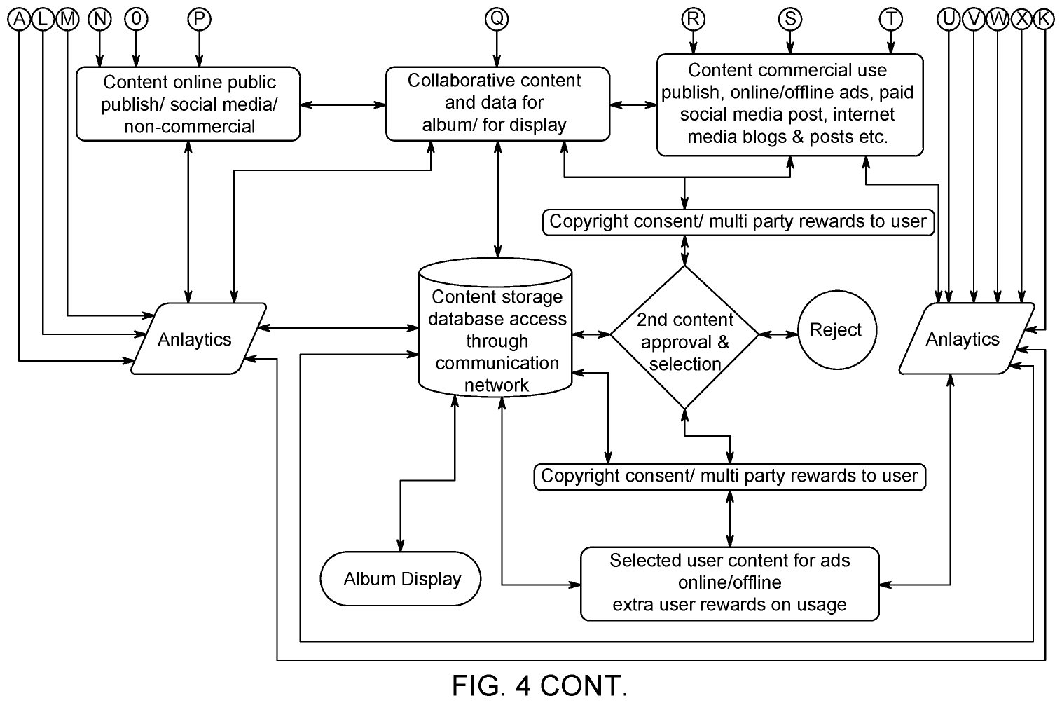

The user interaction, configuration and content management system 110 may utilize the data present in the database 108 linked to objects to visually enhance retail outlet of the brand, increase user engagement, increase online footprint of the brand, and provide targeted discounts to the consumer. The working of the user interaction, configuration and content management system 110 is explained in FIG. 4.

FIG. 4 shows a flowchart depicting method flow 400 for user interaction, configuration and content management system, in accordance with an example embodiment of the present disclosure. As shown in FIG. 4, the data from the wireless tags and triggers such as QR image, NFC, RFID, beacons that are pre-configured or post configured are stored in the collaborative database 108. The data for tangible promotion objects, and multiuser managed configuration information are also stored in the collaborative database 108. The data for tangible promotion objects comprises details of objects placed at different locations, tag information for events and campaign related, organizer, duration and online publish, social publish information. The data from multi user managed configuration comprises configuration data of multiple users, administrator, and third party service providers. The data linked objects are placed at different locations. When a participating device such as a mobile phone of a user having application installed in the mobile device approaches the location, the data linked objects are activated by the wireless tags. The data linked objects may provide an invitation signal to the mobile device of the user 102. The data linked objects also access the collaborative database 108 for configuration information, user information and the like. After the invitation signal is transmitted to the mobile device by the user 102, the user may accept the invitation by providing a user confirmation. The user confirmation may be any type of authentication means such as a One Time Password (OTP), user credentials and the like. Based on the user confirmation, the system 110 may provide a plurality of user engagement tasks and processes such as taking a photo and uploading the photo via the application. After the tasks are completed, the tasks completed by the users are collated and combine to obtain user generated data. The user generated data may comprise photos, videos, product reviews and the like. The user generated content is automatically stored in the collaborative album database 108. The user generated content is then collated as an album and displayed to the public through internet, social media, and the like. Subsequently, the user generated content is subjected to copyright consent from the user 102. The system 110 initiates the copyright consent and content approval processes for the data generated by the user 102. Based on the consent received from the user, the content generated may be used for commercial purpose or non-commercial purpose. When the user generated content is used for commercial purpose, a reward is provided to the user 102. When a plurality of users are involved in generating the content, the reward or revenue may be shared between the users. Further, the user 102 may also be provided with multiparty rewards based on the copyright content used by different brands, different channels such as social media, blogs, and the like or as decided by the system 110. Subsequently, a second level of content approval and selection may be performed on the approved user generated content stored in the collaborative content database 108. The user generated content is then collated as an album and displayed to the public through internet, social media, and the like. The user 102 may provide consent or revoke the already provided consent at any time of the copyright approval/copyright consent process. The user generated content stored in the database 108 may be used by the system 110 to perform analytics such as object analytics, content analytics, buying trends of the user, seasonality of branded products, and the like. The user generated content may also be used for advertisement and analytics may be performed based on the user conversions of the advertisement for additional user rewards.

In an example embodiment, the user interaction, configuration and content management system 110 may be implemented in a retail store of a brand. The retail store may be located in a commercial area such as a shopping mall, a theatre complex and the like. The user interaction, configuration and content management system 110 ensures more users 102 are attracted the retail store. Therefore, the retail store may comprise visual enhancement objects with wireless tag or device to activate and facilitate data link between devices, wireless tags and database 108 for data configuration, user engagement, connection, and for creation, transfer and publishing of user generated digital content. Multiple wireless tags and triggers are attached to the visual enhancement objects so that when the user 102 passes nearby the location, an trigger is sent to the mobile device of the user 102. The visual enhancement objects may be for example, advertisement objects, brand mascot, signage, window decoration objects, instore decoration, commercial decoration, packaging, artwork installation, mall decorations, event and party decoration and publicity, marketing, branding materials, advertisement, promotions, information things related to an event or promotion of products and services of the company, and used for enhancing visual experience of the retail store that are normally static in nature. The user 102 may be attracted to the visually enhancing data objects in the retail store. Further, the system 110 may ensure that the user 102 may take a photo of themself along with the visually enhancing data objects or subject specified in user task by information fetched on interaction with wireless tag. The photo is the content generated by the user 102. The user generated content may be stored in the collaborative content database 108. Based on the copyright consent of the user 102, the system 110 may obtain the user generated data and subsequently collate the user generated content to generate a collaborative album. The collaborative album has multiple users and the system 110 may perform access control for the collaborative album so that adding or removal of users becomes easy and all the users get high quality images. The system 110 may perform the content approval and selection process again to obtain consent of users for public display of user generated content. Based on the consent and approval of the user 102, the album is published in social media, advertisements, and the like. Based on the published user generated content, the user 102 may be provided with multiple rewards. The rewards may be provided by the content owner, brand owner, marketing campaign sponsor, organizer and the like. Thus, users and consumers are rewarded for providing user generated content. The rewards may be monetary rewards, discounted offers, and the like. Also, object analytics are performed on the collaborative content database 108 to identify type of people in photos, their moods such as happy or forced, how users are using the subject, and what needs to be done to improve the photo presence of the location, subject or object, what areas are more visually attractive for user photos, what background looks good in store design, is the store branding visible, store front visible, and the like.

The user interaction, configuration and content management system 110 provides dynamic decoration of the retail store to attract consumers to the store. As wireless tags are used to obtain data from linked objects, the visual experience can be improved in real time based on user feedback. The user 102 is also engaged by utilizing the collaborative album and multiple rewards based on the user generated content. The system 110 also enables quick addition and removal of users from the collaborative album after a predetermined period of time. Thus the data of user 102 are protected and security is enhanced. Further, the data gathered from the user 102 is subjected to analytics and the users are provided with multiple discrete discounts based on the analytical insights thereby the store owner can provide different discounts to various types of users in order to maximize profits and increase consumer engagement with the brand. Thus, the user interaction, configuration and content management system 110 enables the store owner to visually enhance the store, increase online media footprint of the store, and provide incentives and rewards to the customers for increasing customer satisfaction.

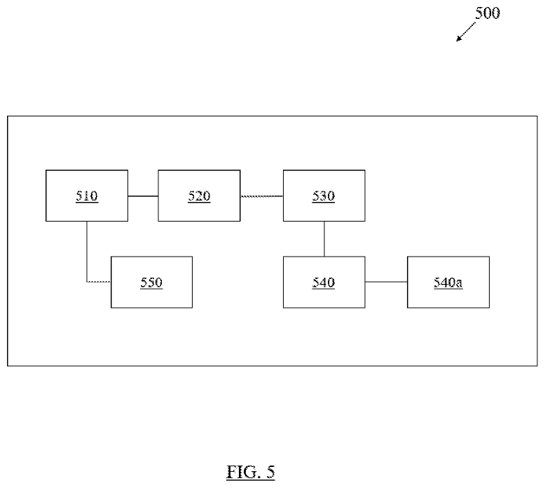

FIG. 5 shows a block diagram of a system 500 for managing content for publication, in accordance with an example embodiment of the present disclosure. The system 500 may function similar to the content management system 110 as described in FIG. 1 and FIG. 2. The system 500 comprises a data storage module 510 configured to store one or more profiles of one or more host facilities. The system 500 further comprises one or more wireless access modules 520 encoded with information to provide an access for a web-based platform 530 to a user. The one or more wireless access modules 520 are implemented on the one or more host facilities. In some embodiments, the host facilities include but are not limited to an even organizing place, a retail store, a gaming station etc. In some embodiments, the one or more wireless access modules is selected from at least one of a 2-dimensional barcodes, Quick response image tag, Radio Frequency Identification tag, Near Field Communication tag, and Bluetooth beacons. The data storage module 510 is to store unique identification code (UID) of each wireless detection module. The system 500 further comprises a user equipment 540 having one or more media recording units 540a and configured to connect with the one or more wireless access modules 520 to receive the encoded information for gaining access to the web-based platform. In an example, the user equipment 540 is at least one of mobile handled device, laptop, PC, or kiosk implemented at a host facility. In some embodiments, the one or more recording units 540 is at least one of an image capturing device and an audio recording device.

The web-based platform 530 is configured to receive inputs by the user. The system 500 further comprises a processor 550 communicably coupled to the data storage module 510 wherein the processor is configured to process the inputs received on the web-based platform 530, create one or user profiles based on the received inputs, store the one or user profiles on the data storage module 510 corresponding to the one or more profiles of the one or more host facilities, generate a first electronic consent for the user to access and monitor the one or more media recording units 540a, upon agreeing to the first electronic consent by the user, monitor electronic signals representing recording of media by the one or more media recording units 540a, generate a second electronic consent for the user to receive the media recorded by the one or more media recording units 540a, and upon agreeing to the second electronic consent by the user, store the recorded media on the data storage module 510.

In some embodiments, upon rejection or selection of the at least one of the first electronic consent and the second electronic consent by the users, the processor 550 is further configured to assign one or more incentivized benefits for the user with respect to a monetary transaction at the one or more host facilities; display, on the user equipment, one or more offers associated with one or more incentivized benefits; and generate a confirmation code indicating a selection of the one or more offers by the user. In an example, the processor 550 updates configuration of corresponding wireless access module. In an example the one or more incentivized benefits may include benefits in a monetary transaction, free access to product and services, spilling of incentivized benefits to multiple users.

In some embodiments, the data storage module comprises a collaborative database unit; where the processer is further configured to provide dynamic data fields over the web-based platform, wherein the dynamic data fields are filled by the user to create setup information and/or reconfiguration of the one or more wireless access modules; assign a unique identification code for the setup information; and store the setup information along with the unique identification code in the collaborative database unit. In some embodiments, the processor is further configured to monitor one or more user activities on the user equipment by using one or more wireless access modules. In some embodiments, the one or more user activities may include monitoring of media recording actions from the user equipment, monitoring of gamification activities of the user.

In some embodiments, the media recorded by the one or more media recording units 540a include but are not limited to photos, audio, any form of text. The media may be further utilized by the host facilities according to copyright management. The copyright management is done between users as without copyright management the content cannot be published publicly and legally and it is of no use. A content provider and content user may agree upon copyright transfer fully or partially to publish or use content publicly. A user may have full rights on their photos if its public location, or no location consent is required to include location in photos (example Eiffel tower cannot be used in photos to sell or publish as advertisement even if the user is in the photo. An organizer may have to publish blocking rights if the location used for content is only allowed to be published by organizer (in store photos cannot be used by user for posting unless allowed by shop. So, a photo of a user taken inside a shop cannot be used by both user and shop owner unless they publish for each other only. The full individual rights or shared rights are managed suitably. In an example, the unique identification code (UID) of each wireless detection module with or without user/s content, content management and publication system with copyright management and enabling sharing with other online or offline publication processes.

In some embodiments, the processor 550 is configured to provide the information associated with wireless module; process the inputs received on the web-based platform; process or update the corresponding wireless module configuration with user content for further user tasks; and store content management and publication system with copyright management and enabling sharing with other online or offline publication processes.

In some embodiments, publication of content (media recorded by the one or more recording units) may be published online media like blogs, photo gallery, articles, chats, social media posts. May also published on offline media like print, video display, radio etc. The content may include published as updated data of wireless access module displayed on user equipment. (Normally, the data of wireless access module in configured by the owner/s representative, in our case we use the user content to update and publish using wireless tag connected to database).

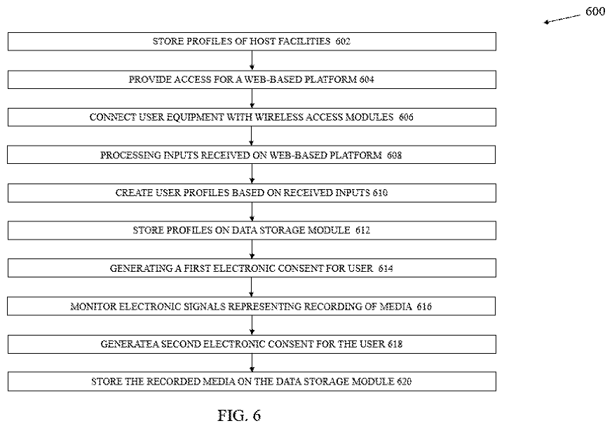

FIG. 6 shows a flowchart of a method 600 for managing content for publication, in accordance with an example embodiment of the present disclosure. The method may be performed by the system 500 described in FIG. 5 of the present disclosure. The method 600 may be implemented by a processing resource 550 or the system 500 through any suitable hardware, non-transitory machine-readable medium, or a combination thereof. In some embodiments, steps involved in the method 600 may be executed by the processing resource, for example the processor 550 (shown in FIG. 5). The processor 550 may be in communication with additional components. The processor 550 may include one or more components operable to execute computer executable instructions or computer code embodied in the memory. The method 600 will be described with reference to FIGS. 1 to 5.

At step 602, the method 600 comprises storing one or more profiles of one or more host facilities on a data storage module.

At step 604, the method 600 comprises providing an access for a web-based platform to a user via one or more wireless access modules encoded with access information, wherein the one or more wireless access modules are implemented on the one or more host facilities, wherein the data storage module is to store unique identification code (UID) of each wireless detection module.

At step 606, the method 600 comprises connecting a user equipment with the one or more wireless access modules to receive the encoded information for gaining access to the web-based platform, wherein the web-based platform is configured to receive inputs by the user.

At step 608, the method 600 comprises processing the inputs received on the web-based platform.

At step 610, the method 600 comprises creating one or user profiles based on the received inputs.

At step 612, the method 600 comprises storing the one or user profiles on the data storage module corresponding to the one or more profiles of the one or more host facilities.

At step 614, the method 600 comprises generating a first electronic consent for the user to access and monitor the one or more media recording units.

At step 616, the method 600 comprises upon agreeing to the first electronic consent by the user, monitoring electronic signals representing recording of media by the one or more media recording units.

At step 618, the method 600 comprises generating a second electronic consent for the user to receive the media recorded by the one or more media recording units.

At step 620, the method 600 comprises upon agreeing to the second electronic consent by the user, storing the recorded media on the data storage module.

In an embodiment the method 600 further comprises storing one or more incentivized benefits for the user on the data storage module.

In an embodiment the method 600 further comprises storing one or more incentivized benefits for the user on the data storage module upon rejection of the at least one of the first electronic consent and the second electronic consent by the users assigning one or more incentivized benefits for the user with respect to a monetary transaction at the one or more host facilities; displaying, on the user equipment, one or more offers associated with one or more incentivized benefits; and generating a confirmation code indicating a selection of the one or more offers by the user.

In an embodiment the method 600 further comprises providing dynamic data fields over the web-based platform, wherein the dynamic data fields are filled by the user to create setup information and/or reconfiguration of the one or more wireless access modules; assigning a unique identification code for the setup information; and storing the setup information along with the unique identification code in the collaborative database unit.

In an embodiment the method 600 further comprises monitoring one or more user activities on the user equipment by using one or more wireless access modules.

Examples of the technology can also be practiced in distributed computing environments where tasks or modules are performed by remote processing devices, which are linked through a communications network, such as a Local Area Network (LAN), Wide Area Network (WAN), or the Internet. In a distributed computing environment, program modules may be located in both local and remote memory storage devices. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, command line interfaces, and other interfaces suitable for the purposes described herein.

Examples of the technology may be stored or distributed on computer-readable media, including magnetically or optically readable computer disks, hard-wired or preprogrammed chips (e.g., EEPROM semiconductor chips), nanotechnology memory, biological memory, or other data storage media. Indeed, computer-implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

Many modifications and other embodiments of the inventions set forth herein will come to mind of one skilled in the art to which these inventions pertain having the benefit of the teachings presented in the foregoing descriptions and the associated drawing. Therefore, it is to be understood that the inventions are not to be limited to the specific embodiments disclosed and that modifications and other embodiments are intended to be included within the scope of the present disclosure. Moreover, although the foregoing descriptions and the associated drawing describe example embodiments in the context of certain example combinations of elements and/or functions, it should be appreciated that different combinations of elements and/or functions may be provided by alternative embodiments without departing from the scope of the present disclosure. In this regard, for example, different combinations of elements and/or functions than those explicitly described above are also contemplated as may be set forth in some of the present disclosure. Although specific terms are employed herein, they are used in a generic and descriptive sense only and not for purposes of limitation.

We claim:

1. A computer-network implemented system for managing content for publication, the system comprising:
a data storage module configured to store one or more profiles of one or more host facilities
one or more wireless access modules encoded with information to provide an access for a web-based platform to a user, wherein the one or more wireless access modules are implemented on the one or more host facilities, wherein the data storage module is to store unique identification code (UID) of each wireless detection module;
a user equipment having one or more media recording units and configured to connect with the one or more wireless access modules to receive the encoded information for gaining access to the web-based platform, wherein the web-based platform is configured to receive inputs by the user; and
a processor communicably coupled to the data storage module wherein the processor is configured to:
process the inputs received on the web-based platform;
create one or user profiles based on the received inputs;
store the one or user profiles on the data storage module corresponding to the one or more profiles of the one or more host facilities;
generate a first electronic consent for the user to access and monitor the one or more media recording units;
upon agreeing to the first electronic consent by the user, monitor electronic signals representing recording of media by the one or more media recording units;
generate a second electronic consent for the user to receive the media recorded by the one or more media recording units; and
upon agreeing to the second electronic consent by the user, store the recorded media on the data storage module.

2. The computer-network implemented system of claim 1, wherein the one or more recording units is at least one of an image capturing device and an audio recording device.

3. The computer-network implemented system of claim 1, wherein the data storage module stores one or more incentivized benefits for the user.

4. The computer-network implemented system of claim 3, wherein upon rejection or selection of the at least one of the first electronic consent and the second electronic consent by the users, the processor is further configured to:
assign one or more incentivized benefits for the user with respect to a monetary transaction at the one or more host facilities;
display, on the user equipment, one or more offers associated with one or more incentivized benefits; and
generate a confirmation code indicating a selection of the one or more offers by the user.

5. The computer-network implemented system of claim 1, wherein the data storage module comprises a collaborative database unit; wherein the processer is further configured to:
provide dynamic data fields over the web-based platform, wherein the dynamic data fields are filled by the user to create setup information and/or reconfiguration of the one or more wireless access modules;
assign a unique identification code for the setup information; and
store the setup information along with the unique identification code in the collaborative database unit.

6. The computer-network implemented system of claim 1, wherein the processor is further configured to monitor one or more user activities on the user equipment by using one or more wireless access modules.

7. The computer-network implemented system of claim 1, wherein the one or more wireless access modules is selected from at least one of a 2-dimensional barcodes, Quick response image tag, Radio Frequency Identification tag, Near Field Communication tag, and Bluetooth beacons.

8. A computer-network implemented method for managing content for publication, the method comprising:
storing one or more profiles of one or more host facilities on a data storage module;
providing an access for a web-based platform to a user via one or more wireless access modules encoded with access information, wherein the one or more wireless access modules are implemented on the one or more host facilities, wherein the data storage module is to store unique identification code (UID) of each wireless detection module;
connecting a user equipment with the one or more wireless access modules to receive the encoded information for gaining access to the web-based platform, wherein the web-based platform is configured to receive inputs by the user;
wherein the method, via a processor, comprises:
processing the inputs received on the web-based platform;
creating one or user profiles based on the received inputs;
storing the one or user profiles on the data storage module corresponding to the one or more profiles of the one or more host facilities;
generating a first electronic consent for the user to access and monitor the one or more media recording units;
upon agreeing to the first electronic consent by the user, monitoring electronic signals representing recording of media by the one or more media recording units;
generating a second electronic consent for the user to receive the media recorded by the one or more media recording units; and
upon agreeing to the second electronic consent by the user, storing the recorded media on the data storage module.

9. The computer-network implemented method of claim 8, wherein the method further comprises storing one or more incentivized benefits for the user on the data storage module.

10. The computer-network implemented method of claim 8, wherein the method, via the processor further comprises:
upon rejection of the at least one of the first electronic consent and the second electronic consent by the users:
assigning one or more incentivized benefits for the user with respect to a monetary transaction at the one or more host facilities;
displaying, on the user equipment, one or more offers associated with one or more incentivized benefits; and
generating a confirmation code indicating a selection of the one or more offers by the user.

11. The computer-network implemented method of claim 8, wherein the method further comprises:
providing dynamic data fields over the web-based platform, wherein the dynamic data fields are filled by the user to create setup information and/or reconfiguration of the one or more wireless access modules;
assigning a unique identification code for the setup information; and
storing the setup information along with the unique identification code in the collaborative database unit.

12. The computer-network implemented method of claim 8, wherein the method further comprises monitoring one or more user activities on the user equipment by using one or more wireless access modules.

13. A non-transitory computer-readable storage medium having a program to perform a method for managing content, wherein the method comprises:
storing one or more profiles of one or more host facilities on a data storage module;
providing an access for a web-based platform to a user via one or more wireless access modules encoded with access information, wherein the one or more wireless access modules are implemented on the one or more host facilities;
connecting a user equipment with the one or more wireless access modules to receive the encoded information for gaining access to the web-based platform, wherein the web-based platform is configured to receive inputs by the user;
wherein the method, via a processor, comprises:
processing the inputs received on the web-based platform;
creating one or user profiles based on the received inputs;
storing the one or user profiles on the data storage module corresponding to the one or more profiles of the one or more host facilities;
generating a first electronic consent for the user to access and monitor the one or more media recording units;
upon agreeing to the first electronic consent by the user, monitoring electronic signals representing recording of media by the one or more media recording units;
generating a second electronic consent for the user to receive the media recorded by the one or more media recording units; and
upon agreeing to the second electronic consent by the user, storing the recorded media on the data storage module.
